(19) United States
(12) Patent Application Publication
(10) Pub. No.: US 2026/0328244 A1
(43) Pub. Date: Oct. 22, 2026

(54) INTEGRATED OUTER RING WIND ROTOR BEARING

(71) Applicant: Schaeffler Technologies AG & Co. KG, Herzogenaurach (DE)

(72) Inventors: Ryan Greenfield, Vernon Hills, IL (US); Fabricius Viana Maia, Sorocaba (BR)

(73) Assignee: Schaeffler Technologies AG & Co. KG, Herzogenaurach (DE)

(21) Appl. No.: 19/180,531

(22) Filed: Apr. 16, 2025

(51) Int. Cl. F16C 19/18; F16C 19/38; F16C 33/40; F16C 33/48; F16C 33/58

(52) U.S. Cl. CPC F16C 19/181; F16C 19/381; F16C 33/40; F16C 33/48; F16C 33/58; F16C 2360/31

(57) ABSTRACT

A bearing assembly for supporting a main shaft of a wind turbine, the wind turbine having at least a blade rotor, a main shaft and a gearbox supported in a nacelle. The bearing assembly includes a housing, at least two bearing raceways formed on a radially inner circumferential surface of the housing, an inner ring, and first and second rows of rolling elements supported by a cage between the inner ring and the inner circumferential surface of the housing.

### TECHNICAL FIELD

The present disclosure relates generally to bearing assemblies and, more particularly, to bearing assemblies for wind turbine applications.

### BACKGROUND

Bearing assemblies are typically circular in shape, and generally comprise rolling elements sandwiched between raceways in bearing rings. Rolling elements take many forms, including spherical balls, rollers or various other configurations, such as cone-shaped tapered rollers or barrel-shaped spherical rollers.

Bearings are widely used in wind power generation, particularly in the nacelle of the turbine, to support components in the gearbox and the main shaft of the wind turbine, which, typically the blade rotor assembly is mounted on. In large size wind turbines, the nacelle can be dozens of meters high above the ground, thus maintaining the bearings supporting the main shaft of the blade rotor assembly can involve substantial labor, costs and often the use of specialized equipment, such as large cranes.

Both radial and thrust loads are generated during power generation cycles in a wind turbine, as a result of the action of the wind on the blade rotors and, in turn, the main shaft. The main shaft bearing, must, therefore, be able to support both radial and axial (or thrust) loads.

Various bearing assemblies are disclosed for rotatably supporting the main shaft of the wind turbine, for example, U.S. Pat. No. 7,918,649 discloses a double row spherical roller assembly with one row having rollers of different lengths from every roller of the other row. A disadvantage of such assemblies is that an entire bearing assembly must be lifted and mounted in place on the main shaft of the wind turbine.

Manufacturers of wind turbines sometimes offer “boost” packages for wind turbines that include refitting a larger rotor onto a wind turbine to produce more power. The larger rotor produces an increased load on the bearing assembly supporting the main shaft of the wind turbine. If unaccounted for in the design of the bearing, the lifespan of the bearing can be greatly reduced. While a typical approach to handling the increased load of the larger rotor would be to provide a larger bearing, space constraints in the nacelle make such approach difficult without also reconfiguring the nacelle which is expensive.

### SUMMARY

In accordance with one aspect a bearing assembly for supporting a main shaft of a wind turbine, the wind turbine comprising at least a blade rotor, a main shaft and a gearbox supported in a nacelle. The assembly comprises at least two bearing raceways formed on a radially inner circumferential surface of a housing supporting the main shaft, an inner ring, and first and second rows of rolling elements supported by a cage between the inner ring and the inner circumferential surface of the housing.

All of the first row of rolling elements can have the same length as all of the second row of rolling elements, and the second row of rolling elements can have a different contact angle than the first row of rolling elements. The second row of rolling elements can have a greater contact angle than the first row of rolling elements. The first row of rolling elements and the second row of rolling elements can be separated by a spacer rib. The assembly can further include sealing elements for sealing axial sides of the bearing assembly.

In accordance with another aspect, a wind turbine comprises a nacelle, a main shaft, a rotor, and a bearing assembly for supporting the main shaft. The bearing assembly includes a housing supported by the nacelle, at least two bearing raceways formed on a radially inner circumferential surface of the housing, an inner ring, and first and second rows of rolling elements supported by a cage between the inner ring and the inner circumferential surface of the housing.

All of the first row of rolling elements can have the same length as all of the second row of rolling elements, and the second row of rolling elements can have a different contact angle than the first row of rolling elements. The second row of rolling elements can have a greater contact angle than the first row of rolling elements. The first row of rolling elements and the second row of rolling elements can be separated by a spacer rib. The bearing assembly can include sealing elements for sealing axial sides of the bearing assembly. The rolling elements can comprise spherical rolling elements.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of an exemplary bearing assembly in accordance with the present disclosure.

FIG. 2 is a schematic illustration of an exemplary wind turbine in accordance with the present disclosure.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

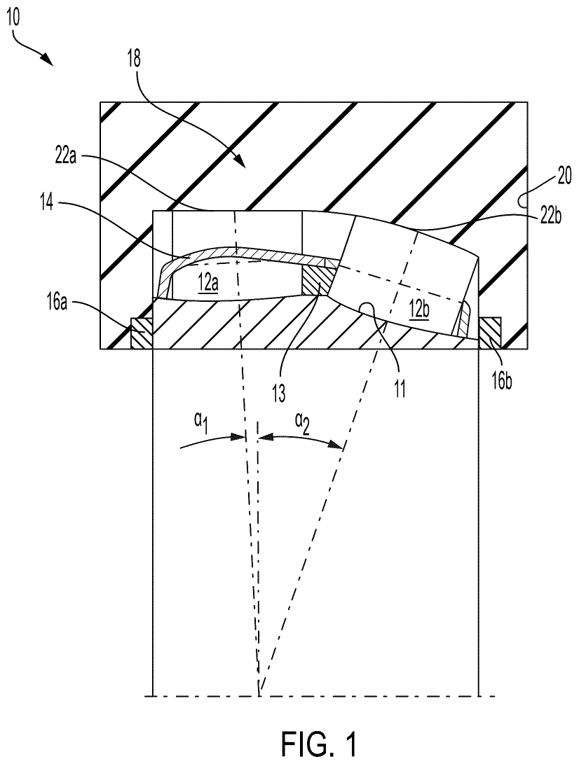

FIG. 1 is a cross sectional view of bearing assembly 10 according to one example embodiment of the present disclosure. Bearing assembly 10 includes an inner ring 11 which can be a symmetric or asymmetric (shown) inner ring having a spherical or tapered roller bearing profile (shown). The bearing assembly 10 includes an upwind rolling element 12a and a downwind rolling element 12b. A fixed rib 13 is provided between the rolling elements 12a and 12b. A two-piece cage 14 contains the rolling elements 12a and 12b. Upwind and downwind seal elements 16a and 16b seal the axial sides of the bearing assembly 10.

In one example embodiment, first row rolling elements 12a operate at contact angle α1 and second row rolling elements 12a operate at contact angle α2, where α1 and α2 are different from each other. In the embodiment shown at FIG. 1, α2 is greater than α1, and therefore, second row rolling elements 12b are better accommodated to support increased thrust loads, for example, from a wind turbine rotor. In this configuration, first row rolling elements 12a would be mounted toward the rotor blades (not shown) of the wind turbine and second row rolling elements would be mounted toward the gearbox side (not shown) of the wind turbine.

In accordance with the present disclosure, an outer ring 18 of the bearing assembly 10 is integrally formed with a housing 20 of the bearing assembly 10. It should be appreciated that the term “outer ring” is used in accordance with common bearing terminology. However, the bearing assembly 10 of the present disclosure does not utilize a separate component comprising an outer ring. Rather, the housing 20 is adapted to comprise an outer ring of the bearing assembly 10. For the purposes of this disclosure, the housing 20 is connected to a bedplate of a nacelle of a wind turbine, but it should be appreciated that aspects of the present disclosure are can be implemented in other applications.

The outer ring 18 generally includes at least two raceways 22a and 22b for the respective rows of rolling elements 12a and 12b. The raceways 22a and 22b can generally comprise annular recesses in the housing 20 that may be formed, for example, by machining. The surfaces of the housing 20 comprising the raceways 22a and 22b can be treated with coatings and/or heat treatment for durability.

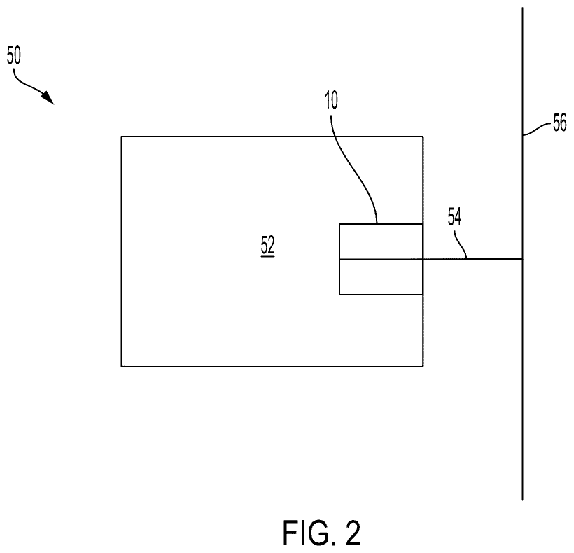

FIG. 2 illustrates an exemplary wind turbine 50 including a nacelle 52. The bearing assembly 10 is supported by the nacelle 52 and supports a main shaft 54 and blade rotor 56 for rotation.

By incorporating the outer ring 18 of the bearing assembly 10 into the housing 20, larger rolling elements 12a/12b can be used as compared to a conventional bearing assembly with a separate outer ring supported in the housing. Accordingly, the capacity of the bearing assembly can be improved without increasing the overall size of the bearing assembly. In addition, aspects of the present disclosure provide:
Asymmetric Geometry: The bearing incorporates asymmetric geometry which enhances thrust load support and minimizes axial displacement
Versatile Design Options: The bearing can be designed as split or unsplit, with the pro-vision for a split housing and split asymmetric geometry. This flexibility supports more efficient servicing and replacement procedures.
Increased Load Capacity: By maximizing the roller diameter while eliminating the separate outer ring, the bearing's load carrying capacity is optimized. Maximizing the roller diameter can lead to lower contact angles and the asymmetric geometry compensates that.
Simplified Maintenance: The integrated design reduces the number of components, leading to quicker and more affordable servicing. The industry moves away from a bearing replacement to a component-driven replacement.
Increased load carrying capacity due to larger roller diameter and elimination of separate outer ring, for example, some embodiments provide a 25-45% increase in capacity as compared to a similar bearing with separate outer ring
Prevention of creeping
Longer operating life

The integration of the outer ring 18 with the housing 20 exemplifies a significant advancement in bearing technology for main shafts in wind turbines, offering enhanced performance, cost efficiency, and ease of maintenance.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying figures.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 Bearing Assembly
11 Inner Ring
12a First Row Rolling Elements
12b Second Row Rolling Elements
13 Fixed Rib
14 Race
16a Seal
16b Seal
18 Outer Ring
20 Housing
22a Raceway
22b Raceway
50 turbine
52 nacelle
54 main shaft
56 blade rotor

What is claimed is:

1. A bearing assembly for supporting a main shaft of a wind turbine, the wind turbine comprising at least a blade rotor, a main shaft and a gearbox supported in a nacelle, the assembly comprising:
a housing;
at least two bearing raceways formed on a radially inner circumferential surface of the housing;
an inner ring; and
first and second rows of rolling elements supported by a cage between the inner ring and the inner circumferential surface of the housing.

2. The bearing assembly according to claim 1, wherein all of the first row of rolling elements have the same length as all of the second row of rolling elements, and the second row of rolling elements has a different contact angle than the first row of rolling elements.

3. The bearing assembly according to claim 1, wherein the second row of rolling elements has a greater contact angle than the first row of rolling elements.

4. The bearing assembly according to claim 1, wherein the first row of rolling elements and the second row of rolling elements are separated by a spacer rib.

5. The bearing assembly according to claim 1, further comprising sealing elements for sealing axial sides of the bearing assembly.

6. The bearing assembly according to claim 1, wherein the rolling elements comprise spherical rolling elements.

7. The bearing assembly according to claim 1, wherein the housing is a bearing housing for supporting the main shaft of the wind turbine.

8. A wind turbine comprising:
a nacelle
a main shaft;
a rotor; and
a bearing assembly for supporting the main shaft;
wherein the bearing assembly includes:
a housing supported by the nacelle;
at least two bearing raceways formed on a radially inner circumferential surface of the housing;
an inner ring; and
first and second rows of rolling elements supported by a cage between the inner ring and the inner circumferential surface of the housing.

9. The wind turbine according to claim 8, wherein all of the first row of rolling elements have the same length as all of the second row of rolling elements, and the second row of rolling elements has a different contact angle than the first row of rolling elements.

10. The wind turbine according to claim 8, wherein the second row of rolling elements has a greater contact angle than the first row of rolling elements.

11. The wind turbine according to claim 8, wherein the first row of rolling elements and the second row of rolling elements are separated by a spacer rib.

12. The wind turbine according to claim 8, further comprising sealing elements for sealing axial sides of the bearing assembly.

13. The wind turbine according to claim 8, wherein the rolling elements comprise spherical rolling elements.
